(19) United States
(12) Patent Application Publication
(10) Pub. No.: US 2018/0048193 A1
(43) Pub. Date: Feb. 15, 2018

(54) METHOD AND APPARATUS FOR SENSING ENVIRONMENT AND OPTIMIZING POWER EFFICIENCY USING AN ANTENNA

(71) Applicant: CommSense Inc., Lafayette, IN (US)

(72) Inventors: Andrew Kovacs, Lafayette, IN (US); Wesley Allen, Lafayette, IN (US)

(21) Appl. No.: 15/676,703

(22) Filed: Aug. 14, 2017

Related U.S. Application Data
(60) Provisional application No. 62/374,026, filed on Aug. 12, 2016.

(51) Int. Cl. H02J 50/90; H04B 5/00

(52) U.S. Cl. CPC H02J 50/90; H04B 5/0037; H04W 52/027

(57) ABSTRACT

Embodiments relate to a sensing device configured to sense the environment of an antenna in a wireless communications or wireless power transfer device without impacting data signal or transferred power integrity. By incorporating a sensing device in the wireless device that operates outside the data signal operating and operational power transfer frequency(s) of the antenna, send/receive data signal integrity may be retained while sensing the environment of the antenna. The sensing device may further use properties of the sensed environment to adjust the configuration of a tunable antenna to decrease signal degradation due to the environment and increase battery life or power transfer efficiency of the wireless device.

### FIELD OF THE INVENTION

This disclosure relates to a device for sensing the environment of a wireless element and more specifically to sensing properties of the environment by measuring electrical characteristics or feedback from the wireless element.

### BACKGROUND

In the wireless power and communications industry, poor battery efficiency in wireless transmission is detrimental to the user experience with those devices. One contributing factor to poor transmission is the changing of the antenna impedance due to the antenna's environment. Whereas wireless communication devices previously utilized efficient external fixed or extendable antennas or were coupled to remote mounted antennas such as in the case of car phones, most modern wireless communication devices feature internal antennas for aesthetic reasons. The internal placement of the antenna in modern wireless communication devices often results in a pronounced negative impact on the user experience. Similarly, alignment and power transfer between devices having inductive charging capabilities experience inefficiencies due to sub optimal alignment between the inductive resonators or charging coils of the charging device and the device being charged.

For example, due to the internal placement of the antenna in modern wireless communication, the impedance of the antenna can change drastically as users alter the way they hold their phone (e.g. from one hand, to both hands, or up to the head). The constantly changing impedance of the antenna leads to energy losses in the transmission and reception of radio signals by the wireless communication device. These losses can be significant and result in severe degradation in battery life of modern wireless communication devices. In extreme cases, holding the wireless communication device in a certain way can cause a total loss of signal potentially resulting in, at best, breaks in call audio transmission and, at worst, the complete dropping of a connection and loss of call audio transmission.

Prior attempts to rectify the issues associated with internal antenna placement have not been successful for a variety of reasons. For example, while a complex antenna array may be implemented to improve signal performance, these configurations are expensive both in economic cost, internal phone real estate, and power consumption of the device. Alternatively, wireless communication devices may include additional added in-line circuitry coupled between the antenna and fundamental transmit/receive components. In such cases, while the circuitry may rectify some of the issues associated with antenna performance in a small set of detectable use cases, the circuitry cannot detect all use cases and realized performance gains come at the cost of overall signal degradation introduced by the presence of the circuitry itself to detect the occurrence of a use case.

Additionally, prior attempts to rectify issues with inductive charging efficiency primarily include the use of a magnet to aid in optimally aligning the phone with the charger. This solution is hard to scale and still does not prevent the inefficiency when misalignment occurs. There is exists a need to aid in the alignment of inductive chargers and prevent the inefficient use of the energy when the device and charging apparatus is not optimally aligned.

### BRIEF SUMMARY OF THE INVENTION

In one aspect, this disclosure is related to a method for sensing an environment of an antenna, the method comprising generating a test signal for transmission into the environment of the wireless element. The signal generated outside of a data or power operating frequency of the antenna can then be tested. The feedback from the antenna corresponding to the test signal and the feedback dependent on the environment of the antenna can then be received. A feedback signal for measurement based on the feedback received from the antenna can be provided. Lastly the feedback signal to sense one or more properties of the environment impact on the antenna is measured.

In another aspect, this disclosure is related to an inductive charging apparatus comprising at least one inductive resonator, a wireless element, and a feedback sensor comprising a signal generator, a feedback detector, and a coupler.

In yet another aspect, this disclosure is related to a wireless communications device comprising: an antenna, and a feedback sensor comprising a signal generator, a feedback detector, and a coupler.

### BRIEF DESCRIPTION OF THE DRAWINGS

The features and advantages of this disclosure, and the manner of attaining them, will be more apparent and better understood by reference to the following descriptions of the disclosed system and process, taken in conjunction with the accompanying drawings, wherein:

FIG. 1A is a bock diagram illustrating an example sensing device for sensing the environment of an antenna.

FIG. 1B is a bock diagram illustrating an example sensing device for sensing the environment of a wireless element.

FIG. 2A is a block diagram illustrating an example coupler configuration of a sensing device for providing a feedback signal to a feedback detector for measurement to sense properties of environment impact on a wireless element, such as an antenna or inductive resonator.

FIG. 2B is a block diagram illustrating additional example coupler configurations for providing a feedback signal to a feedback detector for measurement to sense properties of environment impact on an wireless element.

FIG. 2C is a block diagram illustrating additional example coupler configurations for providing a feedback signal to a feedback detector for measurement to sense properties of environment impact on an wireless element.

FIG. 2D is a block diagram illustrating additional example coupler configurations for providing a feedback signal to a feedback detector for measurement to sense properties of environment impact on an wireless element.

FIG. 3 is a block diagram illustrating an example feedback detector for measuring a received feedback signal to sense properties of environment impact on a wireless element.

FIG. 4 is a block diagram illustrating an example antenna controller for configuring a tunable antenna based on a signature corresponding to sensed properties of an environment of the tunable antenna.

FIG. 5 is a flowchart illustrating an example method for sensing an environment of an antenna.

FIG. 6 is a flowchart illustrating an example method for adjusting a tunable antenna.

FIG. 7 is a diagram of an exemplary embodiment of the present invention including a wireless device equipped with an exemplary embodiment of a feedback detector apparatus and illustration related to portions of the wireless device.

FIG. 8 is a diagram of an exemplary embodiment of the present invention.

### DETAILED DESCRIPTION OF THE INVENTION

The figures and the following description relate to various embodiments by way of illustration only. It should be noted that from the following discussion, alternative embodiments of the structures and methods disclosed herein will be readily recognized as viable alternatives that may be employed without departing from the principles of the embodiments.

Reference will now be made in detail to several embodiments, examples of which are illustrated in the accompanying figures. Wherever practicable, similar or like reference numbers may be used in the figures and may indicate similar or like functionality. The figures depict embodiments for purposes of illustration only.

Embodiments relate to a sensing device configured to sense the environment of a wireless element, such as an antenna, inductive resonator, or other similar element, in a wireless communications device without impacting data signal integrity. By incorporating a sensing device in the wireless communications device that operates outside the data signal operating frequency(s) of the wireless element, send/receive data signal integrity may be retained while sensing the environment of the wireless element. The sensing device may further use properties of the sensed environment to adjust the configuration of a tunable antenna or other wireless element to decrease signal degradation due to the environment and increase battery life and efficiency of the wireless device.

Embodiments also relate to a sensing device configured to sense the environment of a wireless element, such as an antenna, inductive resonator or a coupled inductor, in a wireless power transfer device without impacting power transfer efficiency. By incorporating a sensing device in the wireless power transfer device that operates outside the operating power transfer frequency(s) of the antenna, the power transfer efficiency may be maintained while sensing the environment of the antenna. The sensing device may further use properties of the sensed environment to adjust the configuration of a tunable antenna to increase power transfer efficiency by properly impedance matching the antenna as affected by the environment. Wireless power transfer devices include but are not limited to devices which transmit and/or receive wireless power for the purpose of heating, charging, lighting, and/or powering an external device, object, material, matter, etc. and/or itself. Some example wireless power transfer device applications include battery charging, radio frequency ablation, battery-less electrical circuitry (e.g. passive RFID), etc. The sensing device can also be used to detect misalignment between the devices, such as a phone and inductive charger, to allow a user to ensure optimal alignment for efficient charging or power transfer.

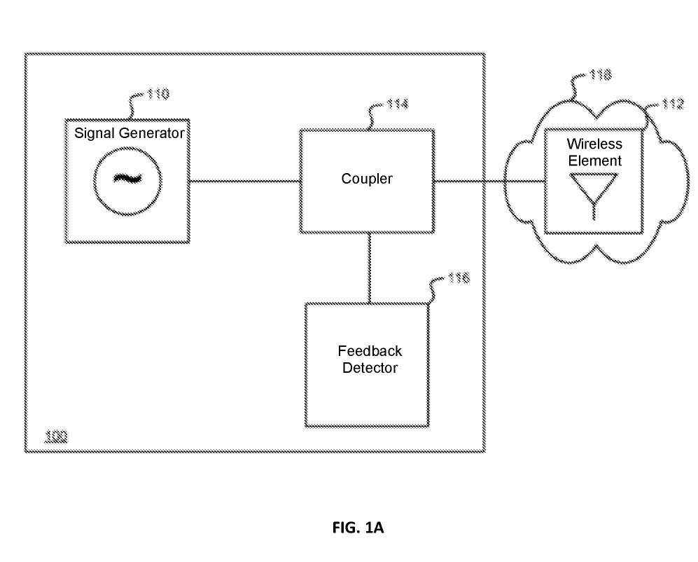

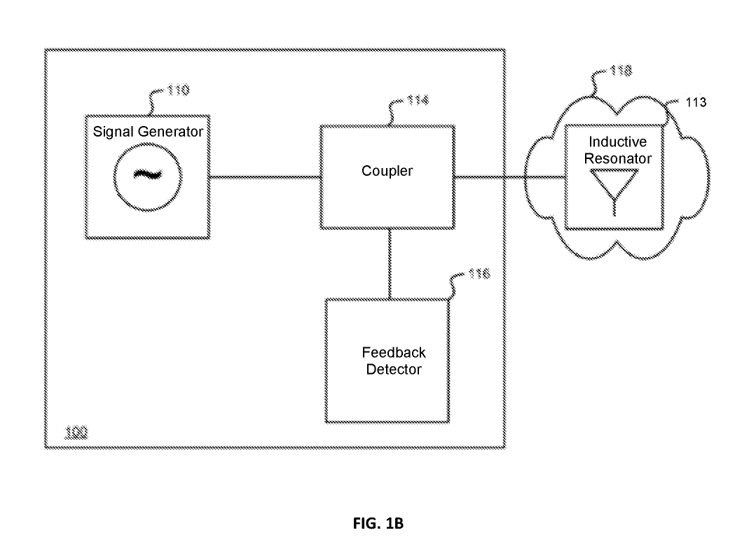

FIG. 1A is a bock diagram illustrating an example sensing device 100 for sensing the environment 118 of a wireless element 112, such as an antenna 112. The sensing device 100 is coupled to the antenna 112, which operates in an environment 118.

In some embodiments, the sensing device 100 is internal to a wireless communication device (not shown) such as a mobile phone or other hand-held device having an antenna 112 (or multiple antennas) enabling wireless communications over WiFi, GSM, CDMA, 2G, 3G, 4G LTE protocols and the like. Accordingly, the antenna 112 may transmit and receive signals carrying wireless communication data such as audio, text, image, video, and the like. Oftentimes, the antenna 112 is incorporated wholly or partially within the enclosure or casing of the wireless communication device. In other instances, the antenna 112 may be aesthetically incorporated as part of the enclosure or casing of the wireless communication device. For example, a surrounding bezel or back-plate of the wireless communication device may include the antenna 112.

In other embodiments, the sensing device 100 is incorporated in a wireless power transfer device. The sensing device 100, however, operates in a similar fashion to that discussed below with reference to a wireless communication device. Accordingly, while the sensing device 100 is discussed in detail with reference to a wireless communication device, wireless power transfer devices may similarly incorporate a sensing device that operates outside the operating power transfer frequency(s) of an antenna (e.g., similar to operating outside the data signal operating frequency(s) of the antenna) such that the power transfer efficiency may be maintained while sensing the environment of the antenna.

Under ideal conditions, such as a wireless communication device operating in a vacuum, the environment 118 of the antenna 112 may include the enclosure or casing of the wireless communication device or other components of the wireless communication device that impact antenna performance. The design and/or placement of the antenna 112 from the factory typically accounts for such considerations. In practice, however, the environment 118 of the antenna 118 changes as a user utilizes the device. For example, different users typically hold the wireless communication device in different ways and a particular user may alter his grip on the wireless communication device, position the wireless communication device against different surfaces such as his face or a table, and/or amongst or in various objects such as in a purse, backpack, room, car, or pocket. The use cases, and other attachments, can present an ever changing environment 118 in which the antenna 112 operates in the wild. Changes in the operating environment 118 of the antenna 112 can impact antenna performance by, for example, altering an impedance of the antenna to different degrees and/or reflecting portions of a transmitted signal back to the antenna. Additionally, amplifier(s) (not shown) in a wireless communication device are designed to achieve optimal efficiency with a specific antenna impedance. Thus, as the environment 118 of the antenna 112 changes and alters the impedance of the antenna, the amplifier(s) may operate less efficiently. The sensing device 100 senses properties of the environment 118 impact on the antenna 112 which may be used to mitigate signal degradation and thus improve battery life of the wireless communication device.

As shown, the sensing device 100 may include a signal generator 110, coupler 114, and feedback detector 116 to sense properties of the environment 118 in which the antenna 112 is operating. The signal generator 110 is coupled to the coupler 114 and can generate test signals for transmission to the antenna 112 and into the environment 118. In one embodiment, the signal generator 110 can generate the test signals on frequencies outside the data signal operating frequency(s) and/or wireless power operating frequency band of the antenna 112. The signal generator 110 may generate a test signal at a discrete frequency, multiple discrete frequencies, or sweep over multiple frequencies. In some embodiments, the test signal generated by the signal generator 110 may be modulated and composed of a range of frequencies. In some embodiments, the sensing device 110 may detect a context of operation of the wireless communication device and the signal generator 110 may generate a test signal of a particular type and more/less frequently based on the context. Example contexts of operator of the wireless communication device may include whether or not the antenna 112 is actively transmitting or receiving data or starting to actively transmit or receive data. The signal generator 110, in turn, may be configured, for example, to generate a test signal less frequently (or not at all) when the antenna 112 is not actively transmitting data (or inactive), generate a test signal more frequently when the antenna is actively transmitting data, and generate a test signal proximate to when the antenna starts to actively transmit or receive data.

The coupler 114 receives the test signals from the signal generator 110 and passes them to the antenna 112 for transmission into the environment 118. The coupler 114 isolates the antenna 112, the signal generator 110, and/or the feedback sensor/detector 116 and passes signals between the various components of the sensor device 100. In some embodiments, the coupler 114 includes transmission lines coupling the antenna 112, the signal generator 110, and/or the feedback sensor 116.

Implementations of the coupler 114 may further include one or more filter(s) (SAW, BAW, discrete components, distributed components, single inductors, single capacitors, etc.) coupled to or between the antenna 112, the signal generator 110, and/or the feedback sensor 116 or otherwise incorporated into the coupler 114 in order to isolate the components of the sensor device 100 from the antenna 112 at the data signal operating frequency(s) of the antenna 112. Examples of filter(s) that may be implemented in the coupler 114 may include a bandstop, bandpass, notch, low-pass, high-pass filter(s), etc., or a combination thereof, in order to pass the test signal frequency(s) and isolate the data signal operating frequency(s) of the antenna 112 and/or isolate frequencies outside the test frequency(s). In some embodiments, the coupler 114 could include impedance matching circuitry. The impedance matching circuitry may be utilized to improve the sensor's sensitivity to environment changes at test signal frequency(s) and/or to allow the setting of specific feedback signal(s) for specific environments.

Additionally, in some embodiments, the coupler 114 may be coupled to the antenna 112 at a physical location on the antenna 112 to improve isolation of the sensor device 100 to the data signal operating frequency(s) of the antenna. In some embodiments, the coupler 114 couples the signal generator 110 to the feedback detector 116 along two paths, one coupled to the antenna 112 and one isolated from the antenna 112. Alternatively or additionally, in some embodiments, the coupler 114 may include directional couplings between the antenna 112 and sensor device 100 components to separate the paths of a test signal for transmission and feedback received from the antenna 112. Embodiments of the coupler 114 may include additional or alternate components to couple the signal generator 110, the antenna 112, and/or the feedback detector 116.

The coupler 114 further receives feedback from the antenna 112 associated with the test signals passed to the antenna and transmitted into the environment 118. More specifically, proximate to when the coupler 114 passes a test signal to the antenna 112 for transmission, feedback associated with the test signal is subsequently received at the coupler 114. The feedback received at the coupler 114 varies depending on the generated test signal, the antenna 112, and the environment 118.

Considering a given test signal and antenna 112, feedback received at the coupler 114 may vary as a result of an altered impedance of the antenna and/or portions of the test signal reflected back to the antenna due to the environment. For example, when the environment close to the antenna 112 (e.g., hand position on the wireless communication device) changes, an impedance of the antenna may change. In another example, when the environment “far” from the antenna 112 (e.g., position in a room, car or, bag the wireless device is operated in and size and/or composition of different rooms, cars or, bags) changes, reflections received at the antenna may occur or change.

Further, considering a given environment 118 and antenna 112, feedback received at the coupler 114 may vary based on the test signal. For example, as two (or more) different environments may result in similar feedback for a given test signal (e.g., at one frequency), by generating another test signal at a different discrete frequency or the initial test signal at multiple discrete frequencies or to sweep over multiple frequencies feedback may be varied to distinguish between the different environments.

Additionally, in embodiments comprising a tunable antenna, considering a given test signal and environment 118, feedback received at the coupler 114 may vary based on the configuration of the antenna. Hence, the configuration of the tunable antenna may be adjusted to compensate based on feedback.

Embodiments of the coupler 114 pass one or more feedback signals based on the feedback received from the wireless element 112 to the feedback detector 116. For example, the coupler 114 may receive feedback corresponding to a test signal and pass a feedback signal comprising significantly unaltered feedback. In another example, the coupler 114 may receive feedback corresponding to a test signal and pass a feedback signal comprising filtered feedback. In yet another example, the coupler 114 may receive feedback corresponding to a test signal and pass a feedback signal comprising the test signal superimposed with the received feedback. Configurations of the coupler 114 may perform one or more of these operations to pass feedback signals to the feedback detector 116. In some embodiments, the coupler 114 may additionally pass received test signals generated by the signal generator 110 to the feedback detector 116 (prior to, and/or subsequent to any filtering performed at the coupler 114). In other embodiments, the signal generator 110 may pass the generated test signals to the feedback detector 116.

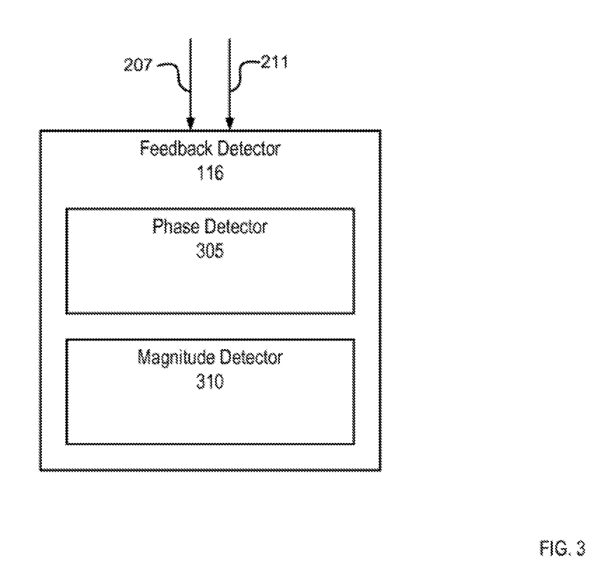

The feedback detector 116 receives one or more feedback signals and/or a test signal and processes one or more of the received feedback signals to sense properties of the environment 118 impact on the antenna 112. For example, the feedback detector 116, which is described in more detail with reference to FIG. 3, may measure a feedback signal directly and/or by performing one or more comparisons between the feedback signal and/or a test signal and/or a corresponding feedback signal to sense properties of the environment 118 impact on the antenna 112.

FIG. 1B is a block diagram illustrating a capacitive or inductive charging apparatus 100 for sensing the environment 118 of an inductive resonator 112. The sensing device 100 is coupled to the inductive resonator 112, which operates in an environment 118. As described above this exemplary embodiment operates similar to the sensing device shown in FIG. 1A. The charging apparatus can sense when an apparatus such as a phone is placed on a charging pad and is not optimally aligned to the inductive resonator which can result into inefficient transfer of energy. The charging apparatus 100 can be used to ensure optimal alignment and/or prevent inefficient transfer of energy between the inductive resonator and the device. In one exemplary embodiment, the coupler can be a capacitor to tune the circuit to the appropriate frequency.

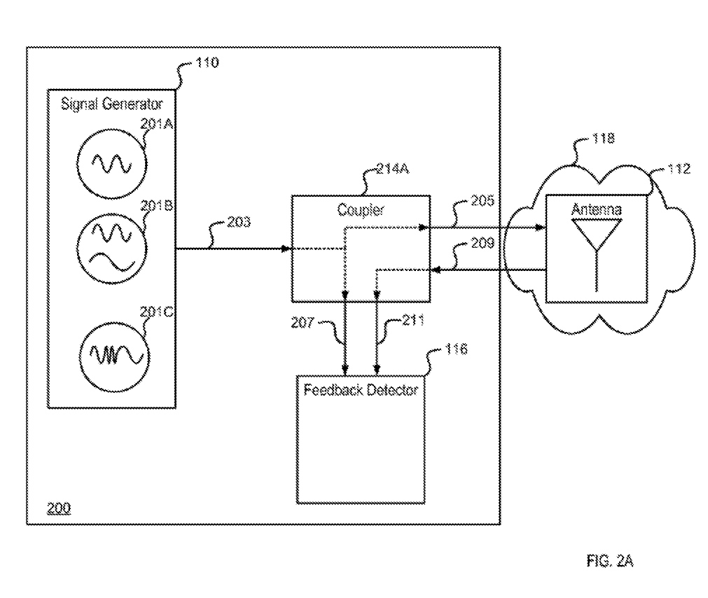

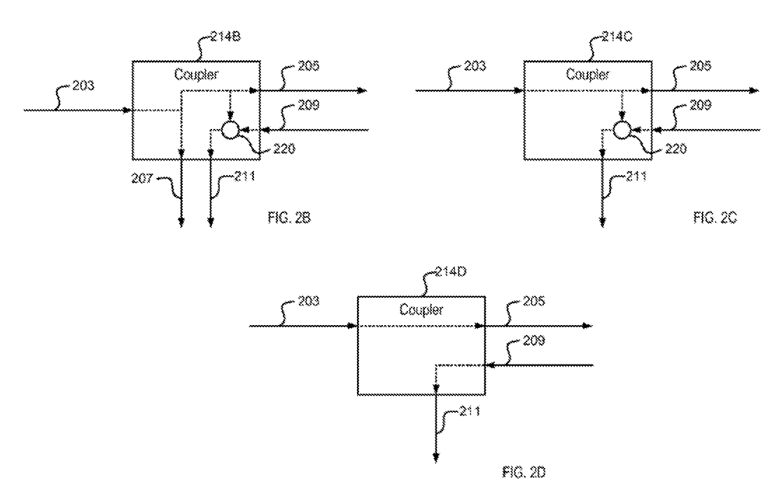

FIG. 2A is a block diagram illustrating an example coupler 214A configuration of a sensing device 200 for providing a feedback signal 211 to a feedback detector 116 for measurement to sense properties of environment 118 impact on an antenna 112.

As shown, the signal generator 110 may generate a number of different test signals. For example, the signal generator 110 may generate a test signal 203 at a discrete frequency 201A, multiple discrete frequencies 201B, or a sweep(s) of frequencies 201C. In some embodiments, the signal generator 110 may generate a modulated test signal 203 composed of a range of frequencies. The signal generator 110 transmits the generated test signal 203 to the coupler 214A. In one embodiment, the signal generator 110 generates the test signals 201A, 201B, 201C at frequencies outside the data signal operating frequency(s) and/or wireless power operating frequency band of the antenna 112.

In the illustrated embodiment, the coupler 214A passes the test signal 205 to the antenna 112 and passes the test signal 207 to the feedback detector 116. The coupler 214A receives feedback 209, as a result of the impedance of the antenna and/or portions of the test signal reflected back to the antenna due to the environment, from the antenna 112 in response to the test signal 205. The coupler 214A, in turn, passes a feedback signal 211 based on the received feedback 209 to the feedback detector 116. The feedback signal 211 may be passed directly and comprise significantly unaltered feedback 209 from the antenna 112. In other embodiments, the coupler 214A may filter the feedback 209 and pass a feedback signal 211 comprising filtered feedback to the feedback detector 116.

The feedback detector 116 measures the feedback signal 211 to sense properties of the environment 118 of the antenna 112. In the illustrated embodiment, the feedback detector 116 receives the test signal 207 and the feedback signal 211 from the coupler 214A. Accordingly, the feedback detector 116 may measure the feedback signal 211 directly and/or perform one or more comparisons between the feedback signal 211 and the test signal 207.

In other embodiments, such as those illustrated in FIGS. 2B-D, the coupler may pass other combinations and/or different signals to the feedback detector 116 for measurement.

FIG. 2B is a block diagram illustrating an example coupler 214B configuration for providing a feedback signal 211 to a feedback detector for measurement to sense properties of environment impact on an antenna. Coupler 214B may be incorporated into the sensing device 200.

In the illustrated embodiment, the coupler 214B receives a test signal 203 from a signal generator. The coupler 214B passes the test signal 205 to an antenna and passes the test signal 207 to a feedback detector for measurement. The coupler 214B receives feedback 209, as a result of the impedance of the antenna and/or portions of the test signal reflected back to the antenna due to the environment, from the antenna in response to the test signal 205. The coupler 214B superimposes 220 the test signal 205 with the feedback 209 received from the antenna to form a feedback signal 211 based on the received feedback 209. In turn, the coupler 214B passes the feedback signal 211 to the feedback detector for measurement.

Thus, the feedback detector receives the test signal 207 and the feedback signal 211 from the coupler 214A. Accordingly, the feedback detector may measure the feedback signal 211 directly and/or perform one or more comparisons between the feedback signal 211 and the test signal 207.

FIG. 2C is a block diagram illustrating an example coupler 214C configuration for providing a feedback signal 211 to a feedback detector for measurement to sense properties of environment impact on an antenna. Coupler 214C may be incorporated into the sensing device 200.

In the illustrated embodiment, the coupler 214C receives a test signal 203 from a signal generator. The coupler 214C passes the test signal 205 to an antenna for transmission. The coupler 214C receives feedback 209, as a result of the impedance of the antenna and/or portions of the test signal reflected back to the antenna due to the environment, from the antenna in response to the test signal 205. The coupler 214C superimposes 220 the test signal 205 with the feedback 209 received from the antenna to form a feedback signal 211 based on the received feedback 209. In turn, the coupler 214C passes the feedback signal 211 to the feedback detector for measurement.

Thus, the feedback detector receives the feedback signal 211 from the coupler 214A. Accordingly, the feedback detector may measure the feedback signal 211 directly to sense properties of environment impact on the antenna. In some embodiments, the signal generator may pass the test signal 203 to the feedback detector such that the feedback detector may perform one or more comparisons between the feedback signal 211 and the test signal 207.

FIG. 2D is a block diagram illustrating an example coupler 214D configuration for providing a feedback signal 211 to a feedback detector for measurement to sense properties of environment impact on an antenna. Coupler 214D may be incorporated into the sensing device 200.

In the illustrated embodiment, the coupler 214D receives a test signal 203 from a signal generator. The coupler 214D passes the test signal 205 to an antenna for transmission. The coupler 214B receives feedback 209, as a result of the impedance of the antenna and/or portions of the test signal reflected back to the antenna due to the environment, from the antenna in response to the test signal 205. The coupler 214D, in turn, passes a feedback signal 211 based on the received feedback 209 to the feedback detector. The feedback signal 211 may be passed directly and comprise significantly unaltered feedback 209 from the antenna. In other embodiments, the coupler 214D may filter the feedback 209 and pass a feedback signal 211 comprising filtered feedback to the feedback detector.

Thus, the feedback detector receives the feedback signal 211 from the coupler 214A. Accordingly, the feedback detector 116 may measure the feedback signal 211 directly to sense properties of environment impact on the antenna. In some embodiments, the signal generator may pass the test signal 203 to the feedback detector such that the feedback detector may perform one or more comparisons between the feedback signal 211 and the test signal 207.

FIG. 3 is a block diagram illustrating an example feedback detector 116 for measuring a received feedback signal 211 to sense properties of environment impact on an antenna. As shown, embodiments of the feedback detector 116 may receive a test signal 207 in addition to the feedback signal 211 for performing measurements. In the illustrated embodiment, the feedback detector 116 includes a phase detector 305 and a magnitude detector 310. Other embodiments of the feedback detector 116 may include one or both of the detectors 305, 310 and/or other types of detectors such as a comparator, zero-crossing, and/or window detector.

The phase detector 305 receives the test signal 207 and the feedback signal 211 and senses the environment 118 of the antenna 112 by detecting a difference in phase between the test signal and the feedback signal. For example, the phase detector 305 may generate an output voltage when the phase between the test signal and the feedback signal differ using well known analog or digital circuitry configurations, such as those suitable for use in a Phase-Locked Loop (PLL). A detected difference in phase between the test signal and the feedback signal may be indicative of a change in impedance of the antenna and/or that portions of the test signal are reflected back to the antenna due to the environment.

In one embodiment, the phase detector 305 generates an output voltage representative of the degree to which the phase between the test signal and the feedback signal differs. For example, the phase detector 305 may generate the output voltage representative of the difference in phase between the test signal and the feedback signal using well known analog or digital circuitry configurations, such as those suitable for use in a PLL. A change in antenna impedance and/or change in the portions of the test signal reflected back to the antenna due to the environment will cause corresponding changes in the received feedback signal 211 and thus the measured phase difference between the test signal 207 and the feedback signal 211. The measured phase difference may be used to differentiate between different operating environments of the antenna. For example, certain environments may exhibit a high degree of difference in phase between the test signal and the feedback signal while others exhibit a minimal degree of difference in phase between the test signal and the feedback signal.

In some instances, the phase difference at one test frequency may be different than the phase difference at another test frequency in an environment. Because multiple environments may correspond to a feedback signal 211 and test signal 207 having the same (or similar) phase difference at one frequency, generation of test signals at different frequencies and/or comprising multiple frequencies may be performed (e.g., by a signal generator) such that the phase detector 305 may measure the phase difference between a test signal 207 and feedback signal 211 at multiple frequencies or sweeps of frequencies to allow improved discrimination between environments.

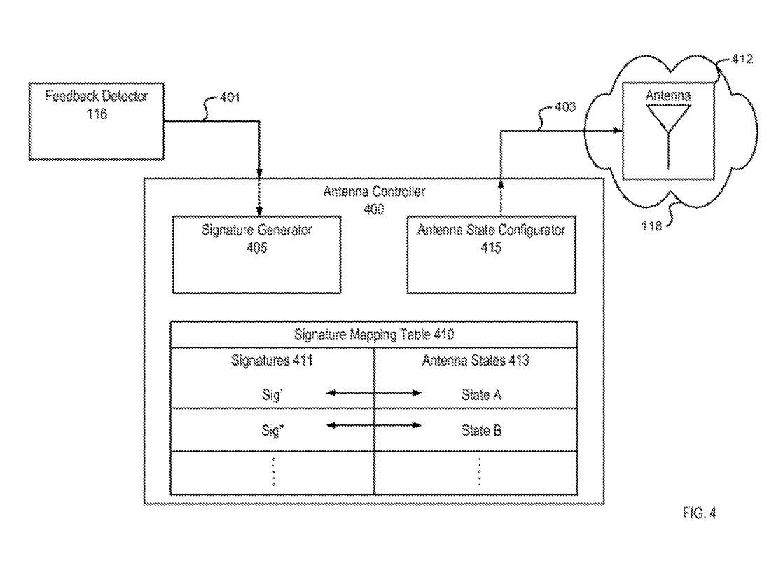

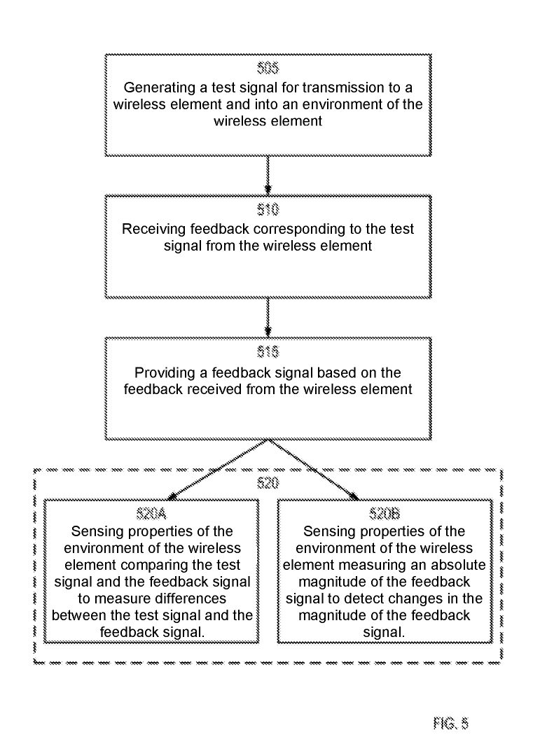

The phase detector 305 may output the detected difference in phase between the test signal 207 and the feedback signal 211 to a tunable antenna controller for altering a configuration of the antenna 112 to account for the sensed environment 118. An embodiment of an antenna controller is described in more detail with reference to FIG. 4.

In one embodiment, the magnitude detector 310 receives the test signal 207 and the feedback signal 211 and senses the environment 118 of the antenna 112 by detecting a difference in magnitude between the test signal and the feedback signal. For example, the magnitude detector 310 may generate an output voltage when the magnitude of the feedback signal exceeds that of the test signal (or vice versa) using well known analog or digital circuitry configurations, such as an operational amplifier comparator.

In another embodiment, the magnitude detector 310 may measure a difference in magnitude between the feedback signal and a reference signal (or voltage) and/or an absolute magnitude of the feedback signal. In such cases, the test signal 207 need not be provided to the magnitude detector 310.

In some embodiments, the test signal input levels and/or the feedback signal input levels are adjusted and/or filtered prior to input into the magnitude detector 310. For example, the level of a signal may be increased (e.g., using an amplifier) or decreased (e.g., using a voltage divider) prior to measurement of the feedback signal and/or comparison of the feedback signal with the test or reference signal to adjust a sensitivity of the measurement and comparison, respectively. Alternatively, or in addition, the signal may be passed through a filter. For example, the magnitude detector 310 may incorporate a filter to limit the frequencies of the test signals and/or feedback signals (e.g., to the range of frequencies outside the data signal operating frequency(s) and/or wireless power operating frequency band of an antenna. At least one filter can be used to eliminate the detectability of the RF system completely. This essentially makes the RF system disappear from recognition. The filter(s) can be used to filter the feedback signal 203 as well as the test signal 205, among others.

A detected difference in magnitude between the test or reference signal and the feedback signal and/or an absolute magnitude (based on changes thereof) of the feedback signal may be indicative of a change in impedance of the antenna and/or that portions of the test signal are reflected back to the antenna due to the environment.

In one embodiment, the magnitude detector 310 generates a voltage representative of the degree to which the magnitude between the reference or the test signal and the feedback signal differ. For example, the magnitude detector 310 may generate the output voltage representative of the difference in magnitude between the test signal and the feedback signal by presenting an envelope detection voltage for each of the signals. The envelope detector detects the envelope power level of the test signal and/or the feedback signal using well known analog or digital circuitry configurations, such as a diode detector, and generates an output voltage corresponding to the magnitude of the test signal and/or feedback signal. A voltage representative of the degree to which the magnitude between the test signal and the feedback signal differ is output based on the difference of the two envelope detection voltages. A voltage representative of the degree to which the magnitude between the reference signal and the feedback signal differ is output based on the difference of the envelope detection voltage of the feedback signal and the reference voltage. A voltage representative of the magnitude of the feedback signal may be output directly.

A change in antenna impedance and/or change in the portions of the test signal reflected back to the antenna due to the environment will cause corresponding changes in the received feedback signal 211 and thus the measured amplitude difference between the reference or test signal 207 and the feedback signal 211 or the absolute magnitude of the feedback signal 211.

The measured magnitude difference or absolute magnitude (based on changes thereof in the feedback signal) may be used to differentiate between different operating environments of the antenna. For example, certain environments may exhibit a high degree of difference in magnitude or large magnitude of the feedback signal and other environments may exhibit a minimal degree of difference in magnitude or minimal magnitude of the feedback signal.

In some instances, the magnitude difference or absolute magnitude of the test signal at one test frequency may be different at another test frequency. Because multiple environments may correspond to a same (or similar) magnitude difference or absolute magnitude at one frequency, generation of test signals at different frequencies and/or comprising multiple frequencies may be performed (e.g., by a signal generator) such that the magnitude detector 310 may measure the magnitude difference or absolute magnitude at multiple frequencies or sweeps of frequencies to allow improved discrimination between environments.

The magnitude detector 310 may output the detected difference in magnitude between the reference or test signal and the feedback signal and/or the absolute magnitude of the feedback signal to an antenna controller for altering a configuration of the antenna 112 to account for the sensed environment 118. An embodiment of an antenna controller is described in more detail with reference to FIG. 4.

FIG. 4 is a block diagram illustrating an example antenna controller 400 for configuring a tunable antenna 412 based on a signature 411 corresponding to the sensed properties of the environment 118 of the tunable antenna. As shown, the antenna controller 400 includes a signature generator 405 for generating a signature corresponding to the sensed properties of the environment 118, a signature mapping table 410 for performing a lookup of the signature to determine a corresponding antenna state, and an antenna state configurator 415 for placing the tunable antenna 412 in the corresponding antenna state. The tunable antenna 412 could be an antenna which has tunable electrical properties. Alternatively the tunable antenna 412 could be an antenna which itself has static electrical properties, but for which circuitry within the device's operating data signal path is tunable (e.g. tunable matching network(s), tunable filter(s), tunable amplifier(s), etc.). The tunable antenna 412 could also be a combination of both an antenna which has tunable electrical properties and an antenna for which circuitry within the device's operating data signal path is tunable.

In one embodiment, the antenna controller 400 is incorporated in the sensing device 100 illustrated in FIG. 1. In another embodiment, the antenna controller 400 may be completely separate or partially separate from the sensing device 100 illustrated in FIG. 1. The antenna controller 400 is coupled to the feedback detector 116 of the sensing device and receives signals 401 describing sensed properties of the environment 118 of the tunable antenna 412 output by the feedback detector 116. The antenna controller 400 processes the received signals 401 to determine a best antenna state and transmits instructions 403 to the tunable antenna 412 to configure the tunable antenna 412 to the desired antenna state.

The signature generator 405 receives the signals 401 describing sensed properties of the environment 118 of the tunable antenna 412 and generates a signature corresponding to the environment 118 based on the sensed properties. Example signals 401 output from the feedback detector 116 and received by the signature generator 405 may include a voltage indicative of a difference in magnitude between a reference or test signal and a feedback signal, a change in the magnitude of the feedback signal, and/or a voltage indicative of a difference in phase between a test signal and a feedback signal. Additionally, a voltage level of a received signal 401 may indicate the degree to which the magnitude or phase of the signals differ and/or the absolute magnitude of the feedback signal. The signature generator 405 generates a signature based on a presence (and/or a level) of the voltage indicative of a difference in magnitude between a reference or test signal and a feedback signal, the voltage indicative of the magnitude of the feedback signal, and/or the voltage indicative of a difference in phase between a test signal and a feedback signal. The signature generator 405 can also account for the different voltages levels at various frequencies when determining the signature.

In one embodiment, the signature generator 405 comprises one or more analog to digital converters which convert the received signals 401 into digital data which can be utilized in software to create a signature. For example, the signature could be an array of magnitude, magnitude difference, and/or phase difference voltages at various frequencies along with a current antenna state and data signal frequency or band: e.g. [M(f1),P(f1),M(f2),P(f2),A,fd] where M and P are magnitude and phase difference voltages, respectively, at f1 and f2, two test signal frequencies, A is the current antenna state, and fd is the frequency or band of the data signal. In one implementation, the signature generator 405 may perform multiple successive complete signature generations based on multiple successive signals 401 describing sensed properties of the environment 118 of the tunable antenna 412 and average the successive signatures to generate one signature with decreased noise. The signature generator 405 outputs the generated signature for lookup in the signature mapping table 410.

The signature mapping table 410 includes a number of signatures 411 and their corresponding antenna states 413 that provide best antenna performance. In one embodiment, the signature mapping table 410 is constructed during development of the wireless communications device by, for example, placing the wireless communication device in a given environment, sensing properties of the given environment (i.e., with the sensing device 100), sweeping antenna states, generating a signature 411 (i.e., Sig′) based on the sensed properties, and testing which antenna state (i.e., State A) provides the best performance in each data signal frequency or band. By placing the wireless communication device in different environments 118 and antenna states in this manner, different signatures (i.e., Sig′, Sig″, etc.) can be generated and each matched to a best antenna state (e.g., State A, State B, etc.).

In some embodiments, the signature mapping table 410 may be populated with signatures generated during the course of operation of the wireless communication device by testing possible states of the tunable antenna 412 against a given signature to determine which state produces the best results. Thus, for example, if a generated signature differs from the signatures stored in the mapping table 410, a best antenna state may be determined. In some embodiments, for a signature not found in the mapping table 410, an objective function of the generated signature and the mapping table signatures 411 may be optimized to determine a corresponding signature in the mapping table. In turn, the antenna state mapped to the corresponding signature, which optimizes the objective function, may be stored in association with the generated signature as a new entry in the mapping table 410.

During wireless communication device operation, the signature mapping table 410 is queried with a generated signature (e.g., by the signature generator 405) and performs a lookup in the table to find a best matching test signature 411 stored in the table. In turn, the signature mapping table 410 outputs the antenna state 413 (e.g., to the antenna state configurator 415) corresponding to the best matching test signature 411.

The antenna state configurator 415 receives antenna state 413 information from the signature mapping table 410 and transmits instructions 403 to the tunable antenna 412 to configure the tunable antenna 412 to the desired state. In turn, the tunable antenna 412 operates in an antenna state best suited to the sensed environment 118 to improve performance and/or increase battery life of the wireless communication device.

FIG. 5 is a flowchart illustrating an example method for sensing the environment of an antenna. As a user utilizes a wireless communication device, the environment presented to an antenna of the wireless communication device may change as the user alters their grip on the wireless communication device, positions the wireless communication device against different surfaces such as their face or a table, and/or amongst various object such as in a purse, backpack or pocket. These changes in the environment can affect antenna performance and negatively impact battery life of the wireless communication device. A sensing device, such as that illustrated in FIG. 1, may be used to sense properties of the operating environment of the antenna.

To sense properties of an operating environment of a wireless element, such as an antenna or inductive resonator, a signal generator generates 505 a test signal for transmission to a wireless element and into an environment of the wireless element. The signal generator may generate 505 the test signal at a discrete frequency, multiple discrete frequencies, or sweep over multiple frequencies outside the data signal operating frequency(s) and/or wireless power operating frequency band of the wireless element to prevent interference with data transmit/receive operations of the wireless element. In some embodiments, the test signal is modulated.

A coupler isolating the wireless element from the signal generator receives the test signal and passes the test signal for transmission into the environment to the wireless element. The coupler receives 510 feedback corresponding to the test signal from the wireless element. The received feedback depends on the environment of the wireless element as the environment alters an impedance of the wireless element to different degrees and/or reflects portions of the test signal transmitted by the wireless element back to the wireless element.

The coupler isolates the wireless element from a feedback sensor and provides 515 a feedback signal based on the feedback received from the wireless element to the feedback sensor. Additionally, the coupler may isolate the signal generator from the feedback sensor and passes the received test signal to the feedback sensor.

The feedback sensor measures 520 the feedback signal to sense properties of the environment impact on the wireless element.

In one embodiment, the feedback sensor receives the test signal and the feedback signal and senses properties of the environment impact on the wireless element by comparing 520A the signals to measure differences between the test signal and the feedback signal. For example, the feedback sensor may measure a detected difference in phase and/or magnitude between the test signal and the feedback signal. The feedback sensor may alternatively utilize a reference signal instead of the test signal to measure a detected difference in magnitude.

In another embodiment, the feedback sensor receives the feedback signal and senses properties of the environment impact on the wireless element by measuring 520B an absolute magnitude (or changes thereof) of the feedback signal to detect changes in the magnitude of the feedback signal.

In some embodiments, the feedback sensor generates a voltage level corresponding to the absolute magnitude (or changes thereof) of the feedback signal and/or degree to which the measured phase or magnitude of the test signal and the feedback signal differ. The feedback sensor may output the voltage level to an antenna controller for processing to adjust a wireless element state of a tunable antenna based on sensed properties of the environment of the wireless element.

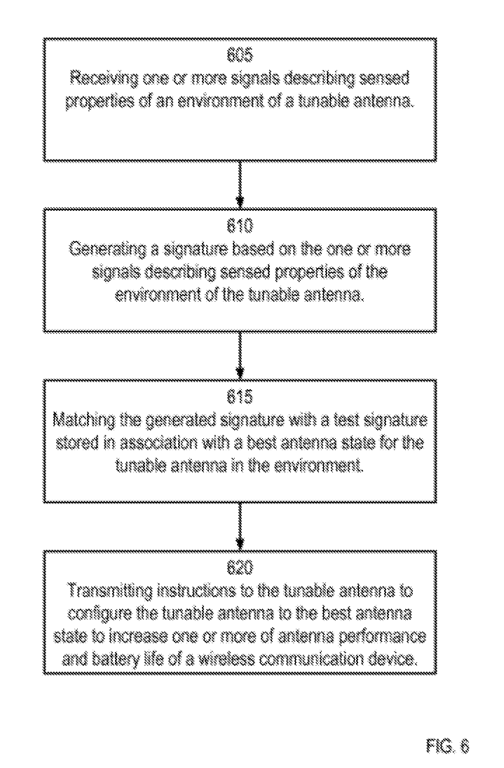

FIG. 6 is a flowchart illustrating an example method for adjusting a tunable antenna. Detected differences between a test signal and a feedback signal based on sensed properties of an environment of a tunable antenna and/or absolute magnitude (or changes thereof) may be processed to configure the tunable antenna to an antenna state best suited for the environment. An antenna controller, such as that illustrated in FIG. 4, may be used to adjust the tunable antenna.

To adjust a tunable antenna, a signature generator receives 605 one or more signals describing sensed properties of an environment of the tunable antenna. Example received 605 signals comprise a voltage indicative of an absolute magnitude (or changes thereof) of a feedback signal, a difference in magnitude between a test signal and a feedback signal, and/or a voltage indicative of a difference in phase between a test signal and a feedback signal. A voltage level of a received 605 signal may indicate the degree to which the magnitude or phase of the test signal and the feedback signal differ or the absolute magnitude (or changes thereof) of the feedback signal.

The signature generator generates 610 a signature based on the one or more signals describing sensed properties of the environment of the tunable antenna and outputs the generated signature.

A signature mapping table receives the generated signature and then matches 615 the generated signature with a test signature stored in association with a best antenna state for the tunable antenna in the environment in the signature mapping table. The signature mapping table outputs the best antenna state for the tunable antenna in the environment.

An antenna state configurator receives the best antenna state and transmits 620 instructions to the tunable antenna to configure the tunable antenna to the best antenna state to increase one or more of antenna performance and battery life of a wireless communication device.

In another exemplary embodiment, the feedback sensor apparatus can have a plurality of antennas and a plurality of feedback detectors. Each antenna can have a corresponding dedicated feedback detector.

The feedback detector apparatus has a large scope of applications and system that it can be incorporated into, thereby providing greater functionality to the system as well as improving the efficiency of the device or system. In one exemplary embodiment, the feedback detector apparatus can be incorporated into a wireless device, such as a cellular phone. The feedback detector apparatus can then take measured information and direct the cellular phone to improve the impedance mismatch by impedance matching the wireless element, such as an antenna of the cellular device, thereby constantly impedance matching as said phone is manipulated or moved in space. This constant impedance matching is necessary due to different environmental changes that the phone is traveling through.

For example, as a user is operating the phone at a given position, they may be moving throughout a structure or change how they are holding the phone. These changes create different impedances related to the wireless element, such as an antenna and must be accounted for in real time to ensure that the device or phone can operate efficiently. This not only increases the efficiency of power consumption by the devices and increases the battery life of the device, but also can affect the efficiency on a larger cellular infrastructure scale. Because the device is able to optimally sense and transmit information to the network, fewer cellular towers are needed per area to provide the same reception to users.

As previously noted, a feedback sensor apparatus can produce at least one output based on measurement of the feedback signal associated with the test signal at the first frequency and a second output based on a measuring of a second feedback signal associated with the second test signal at the second frequency. In this embodiment, the first output and the second output for discriminating between a first environment and a second environment have a similar feedback response at the first frequency and a distinct feedback response at the second frequency.

In one embodiment, the tunable antenna and antenna controller of the feedback sensor apparatus can, in addition to configuring the tunable antenna to an antenna state best suited for the environment, be used to provide greater functionality to a device, such as a cell phone. Many phones have limited space on the external portion of the device for ancillary buttons to operate features of the phone, such as the power button, volume controls, and the menu button among others. Integrating the feedback sensor apparatus with the phone can provide greater functionality to an already existing phone without the need of additional external buttons. Additionally, the feedback sensor apparatus can effectively operate as a replacement for external control buttons or switches. This can allow cellular phone manufacturers the ability to eliminate external buttons/switches from the phone. This can aid in the manufacturing process, increase durability and weather resistance, as well as providing greater ability to make a phone thinner.

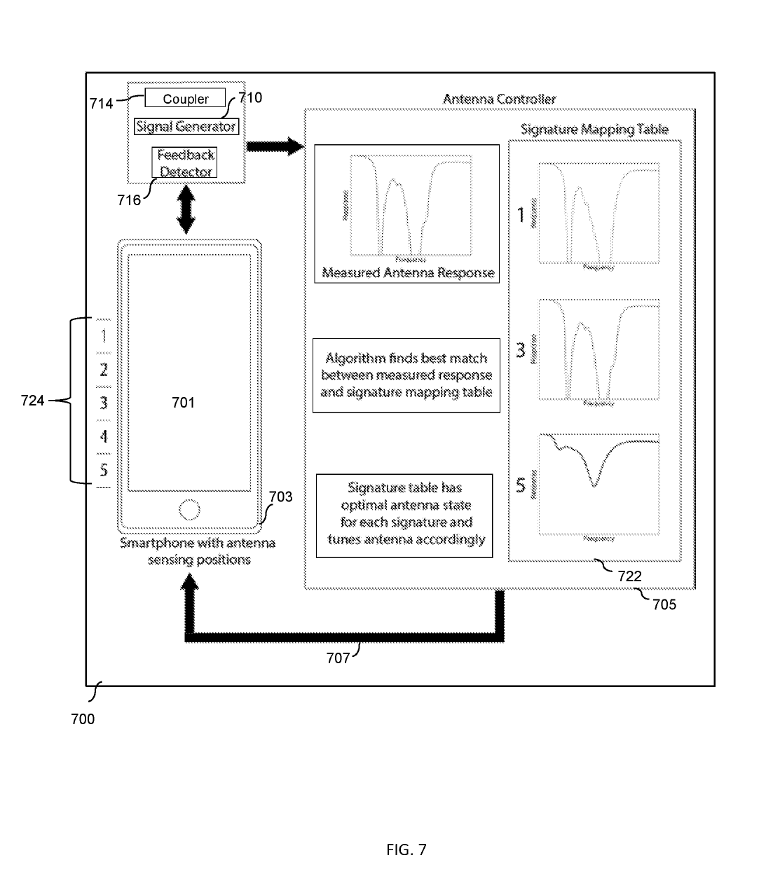

As shown in FIG. 7, in one exemplary embodiment, an apparatus 700 can include a feedback sensor communicatively coupled to a mobile device 701, such as a cellular phone. The mobile device can include a microprocessor, memory, and data bus. The mobile device can further include a display. The apparatus 700 can include a signal generator 710, a coupler 714, a feedback detector 716, and an antenna controller or tuner 705, similar to that shown in FIG. 4. The feedback detector 716 can analyze at least one sensor output 707 and compare the sensor output(s) 707 to a table of lab-measured outputs, stored in a signature mapping database 722. The database 722 can be stored on a memory, such as memory found in the mobile device 701 or an external or cloud memory communicatively connected to the mobile device 701. The table of lab-measured outputs can be mapped to correlate to one or more distinctive locations 724 on the mobile device, essentially creating a fingerprint for the device 701. Each distinctive location 724 can be associated with an optimal matching network configuration to minimize the impedance mismatch between the antenna 703 and the radio subsystem. This can reduce the amount of power needed for proper operation of the radio system, saving power, extending battery life, and thus extending the life of the device.

Additionally, the measured distinctive location 724 can be compared to a table of lab measured cases in the signature mapping database 722 that are correlated to various finger or hand positions a user might implement around the exterior of the device in positional relationship to the antenna 703. The feedback sensor apparatus 700 can be used to monitor how these positions change over time and in real time while the mobile device 701 is in operation. In combination with a manometer and accelerometer, the apparatus 700 can determine the orientation of the mobile device 701 and anticipate the use of the phone by the user, such as determining whether the device 701 is being held up to a user's ear or a user is typing or texting on the phone. This information can be used to determine whether to activate the additional functionality to the device 701 provided by the apparatus 700. These finger and hand positions can be mapped and correlated to the outputs 707 from the feedback detector 716 and antenna controller 705, and thus made functional. Different sequences of hand and finger positions can be distinguished by the feedback detector 716 apparatus and then communicate with the device to perform a certain functions based on the outputs 707.

FIG. 7 further illustrates how distinctive locations 724 using finger and hand positions can be used to provide additional function to the device. For example, the antenna 703 of the feedback sensor 700 can sense a user swiping across the external edge of the device 701. This can be used to turn the volume up or down depending upon the desired functionality. Alternatively it could be used to adjust the brightness or contrast of the screen. Similarly, buttons can essentially be created without the need of a physical button to be present. These different finger positions along the external antenna or the exterior of the mobile device 701 can be correlated to various functions of the phone including but not limited to use as passwords or access keys, quick keys or hot keys for designated functions, as well as other functionality desired by a user.

Similarly, another exemplary embodiment of the present invention includes an optional feedback detector communicatively coupled with inductive resonators 113, as shown in FIG. 1B. This embodiment includes an inductive charging apparatus having greater efficiency when charging a device or a power source, such as a battery for a device. The inductive charging apparatus using the feedback sensor can further comprise a resonator that operates outside the operating range or frequency band of the antenna to prevent interference or affect the functionality of the antenna. In one exemplary embodiment, the inductive charging apparatus comprising the feedback sensor which only measures the magnitude difference between the test signal and the feedback signal and is not concerned with the phase between the two signals. This inductive charging apparatus can be used for a variety of applications, including charging phones or battery powered and hybrid cars. The primary advantage that the feedback sensor provides is the ability to accurately identify the alignment of the inductive charging apparatus with the targeted device that is to be charged. In many applications, a misalignment between the inductive charging source and the target results in inefficient charging and the wasting of power. This inefficiency often generates excessive heat that in turn has a negative effect on the lifespan of the power source. This can also negatively affect the lifespan of components within and the device itself.

The optimal power transfer happens when coupling between the coils of the target and source is maximized. The coupling also helps to determine the impedance of the charging resonator and determine the impedance of the charging system. If the coils are not optimally aligned, the coupling will be suboptimal and the impedance of the charging coil will also be different from the driving circuit, wasting power. Using similar procedure as previously described, the feedback sensor can match the impedance. This may not increase the power transfer of the inductive charger to the other coil, but it greatly reduces wasted power created by the impedance mismatch.

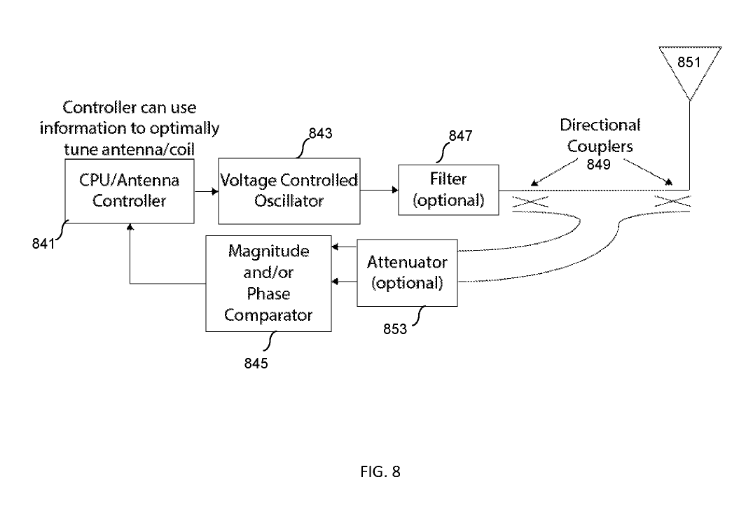

As shown in FIG. 8, in one exemplary embodiment, the present invention can be comprised of a microcontroller 841, a voltage controlled oscillator 843, a magnitude and/or phase detector 845, at least one filter 847, and a coaxial output/directional couplers 849 to an antenna 851. The present invention can further include a feedback loop for microcontroller control. The filter 847 can be used to avoid interference with the wireless signal. Additionally, the system can further include an attenuator 853. The present invention operates outside the bandwidth of the operation signal of the device. By operating out of the signal bandwidth, interference is avoided and the resolution can be greatly increased. In some exemplary embodiments, the compared signals do not have follow the exact same path. So in one case the transmitted signal can traverse a first path and the reflected signal can traverse a second path back to the detector. Alternatively, the transmitted and reflected signals can traverse the same path.

While particular embodiments and applications have been illustrated and described, it is to be understood that the embodiments are not limited to the precise construction and components disclosed herein and that various modifications, changes and variations may be made in the arrangement, operation and details of the method and apparatus disclosed herein.

What is claimed is:

1. A method for sensing an environment of an wireless element, the method comprising:
generating a test signal for transmission into the environment of the wireless element, the test signal generated outside of a data signal operating frequency of the wireless element;
receiving feedback from the antenna corresponding to the test signal, the feedback dependent on the environment of the wireless element;
providing a feedback signal for measurement based on the feedback received from the wireless element; and
measuring the feedback signal to sense one or more properties of the environment impact on the wireless element.

2. The method of claim 1, wherein measuring the feedback signal to sense one or more properties of the environment impact on the antenna comprises comparing the test signal and the feedback signal to measure a difference between the test signal and the feedback signal.

3. The method of claim 2, wherein a measured difference between the test signal and the feedback signal is one or more of a difference in phase and a difference in magnitude.

4. The method of claim 1, wherein measuring the feedback signal to sense one or more properties of the environment impact on the antenna comprises measuring a magnitude of the feedback signal.

5. The method of claim 1, further comprising generating the test signal at a first frequency; and generating a second test signal at a second frequency, the second frequency different from the first frequency.

6. The method of claim 1, wherein the test signal comprises a signal at a single discrete frequency.

7. The method of claim 1, wherein the test signal comprises a signal having multiple discrete frequencies.

8. The method of claim 1, wherein the test signal comprises a signal sweeping over a frequency range.

9. The method of claim 1, further comprising comparing the test signal to a signature mapping table comprising a table or stored test signals.

10. A device for sensing an environment of an antenna, the device comprising:
a signal generator configured to generate a test signal outside of a data signal operating frequency of the antenna, the test signal for transmission into the environment of the antenna;
a feedback detector configured to perform one or more measurements on a feedback signal corresponding to the test signal to sense properties of the environment impact on the antenna;
a coupler configured to isolate and pass signals between the signal generator, the feedback detector, and the antenna, where the coupler receives the test signal from the signal generator to pass the test signal to the antenna and receives feedback from the antenna to pass the feedback signal to the feedback detector; and
an antenna controller configure to generate an output signal to the device, wherein the output signal is based upon the correlation of the test signal to a signature mapping table.

11. A wireless communication device comprising:
an antenna having at least one data signal operating frequency;
a microprocessor; and
a feedback sensor comprising a signal generator, a feedback detector, and a coupler.

12. The device of claim 11, further comprising at least one filter.

13. The apparatus of claim 11, further comprising an inductive resonator, wherein the inductive resonator, antenna, and feedback sensor are communicatively coupled by inductively coupled circuits.

14. The apparatus of claim 11, further comprising an antenna controller for configuring a tunable antenna based on a sensed signal from the antenna.

15. The apparatus of claim 15, further comprising a memory having a signature mapping database.

16. The apparatus of claim 16, wherein the signature mapping database comprises a table of measured outputs mapped to correlate to one or more distinctive locations on the wireless communication device.

17. The apparatus of claim 17, wherein a user can touch one or more of the distinctive locations on the wireless communications device, wherein the microprocessor initiates to a function of the mobile device based on the output generated by the antenna controller.

18. The apparatus of claim 18, wherein the wireless communications device includes a display, wherein the additional feature includes adjusting screen brightness of the wireless communications device display.

19. The apparatus of claim 14, wherein the feedback sensor is configured to sense when an apparatus is optimally aligned with the indicative resonator to ensure optimal transfer of energy.
